(19) United States
(12) Patent Application Publication
(10) Pub. No.: US 2012/0200406 A1
(43) Pub. Date: Aug. 9, 2012

(54) METHODS, SYSTEMS, AND COMPUTER PROGRAM PRODUCTS FOR DIRECTING ATTENTION OF AN OCCUPANT OF AN AUTOMOTIVE VEHICLE TO A VIEWPORT

(76) Inventor: Robert Paul Morris, Raleigh, NC (US)

(21) Appl. No.: 13/023,883

(22) Filed: Feb. 9, 2011

(51) Int. Cl. B60Q 1/00

(52) U.S. Cl. 340/439

(57) ABSTRACT

Methods and systems are described for directing attention of an occupant of an automotive vehicle to a viewport. Interaction information is received for monitoring an operator of an automotive vehicle that includes a first viewport as a first source of visual input for the operator and a second viewport as a second source of visual input for the operator. A detection is made that a first attention criterion is met for the first viewport and that a second attention criterion is met for the second viewport. In response to the detection, a determination is made that the first viewport has a higher priority than the second viewport. In response to the determination, first attention information is sent to present a first priority indicator, via a first output device, to identify the first viewport as a higher priority source of visual input for the operator than the second viewport.

### RELATED APPLICATIONS

This application is related to the following commonly owned U.S. patent applications, the entire disclosures being incorporated by reference herein: application Ser. No. ______ (Docket No 0133) filed on 2011 Feb. 9, entitled “Methods, Systems, and Program Products for Directing Attention to a Sequence of Viewports of an Automotive Vehicle”;

Application Ser. No. ______ (Docket No 0170) filed on 2011 Feb. 9, entitled “Methods, Systems, and Program Products for Altering Attention of an Automotive Vehicle Operator”; and

Application Ser. No. ______ (Docket No 0171) filed on 2011 Feb. 9, entitled “Methods, Systems, and Program Products for Managing Attention of an Operator of an Automotive Vehicle”.

### BACKGROUND

Driving while distracted is a significant cause of highway accidents. Recent attention to the dangers of driving while talking on a phone and/or driving while “texting” have brought the public's attention to this problem. While the awareness is newly heightened, the problem is quite old. Driving while eating, adjusting a car's audio system, and even talking to other passengers can and does take drivers' attention away from driving, thus creating and/or otherwise increasing risks.

While inattention to what is in front of a car while driving is clearly a risk, many drivers even when not distracted by electronic devices, food, and other people pay little attention to driving related information provided by mirrors, instrument panels, and more recently, cameras.

A need exists to assist drivers in directing their attention to a number of views in various directions relative to the location of a driver to increase driving safety. Accordingly, there exists a need for methods, systems, and computer program products for directing attention of an occupant of an automotive vehicle to a viewport.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

Methods and systems are described for directing attention of an occupant of an automotive vehicle to a viewport. In one aspect, the method includes receiving, via an input device, interaction information for monitoring an operator of an automotive vehicle that includes a first viewport as a first source of visual input for the operator and that includes a second viewport as a second source of visual input for the operator. The method further includes detecting, based on the interaction information, that a first attention criterion is met for the first viewport and that a second attention criterion is met for the second viewport. The method still further includes determining, in response to detecting that the first attention criterion is met and that the second attention criterion is met, that the first viewport has a higher priority than the second viewport. The method also includes sending, in response to determining that the first viewport has the higher priority, first attention information to present a first priority indicator, to the operator, via a first output device, to identify the first viewport as a higher priority source of visual input for the operator than the second viewport.

Further, a system for directing attention of an occupant of an automotive vehicle to a viewport is described. The system includes an interaction monitor component, a viewport monitor component, an attention priority component, and an attention director component adapted for operation in an execution environment. The system includes the interaction monitor component configured for receiving, via an input device, interaction information for monitoring an operator of an automotive vehicle that includes a first viewport as a first source of visual input for the operator and that includes a second viewport as a second source of visual input for the operator. The system further includes the viewport monitor component configured for detecting, based on the interaction information, that a first attention criterion is met for the first viewport and that a second attention criterion is met for the second viewport. The system still further includes the attention priority component configured for determining, in response to detecting that the first attention criterion is met and that the second attention criterion is met, that the first viewport has a higher priority than the second viewport. The system still further includes the attention director component configured for sending, in response to determining that the first viewport has the higher priority, first attention information to present a first priority indicator, to the operator, via a first output device, to identify the first viewport as a higher priority source of visual input for the operator than the second viewport.

### BRIEF DESCRIPTION OF THE DRAWINGS

Objects and advantages of the present invention will become apparent to those skilled in the art upon reading this description in conjunction with the accompanying drawings, in which like reference numerals have been used to designate like or analogous elements, and in which:

FIG. 1 is a block diagram illustrating an exemplary hardware device included in and/or otherwise providing an execution environment in which the subject matter may be implemented;

FIG. 2 is a flow diagram illustrating a method for directing attention of an occupant of an automotive vehicle to a viewport according to an aspect of the subject matter described herein;

FIG. 3 is a block diagram illustrating an arrangement of components for directing attention of an occupant of an automotive vehicle to a viewport according to another aspect of the subject matter described herein;

FIG. 4a is a block diagram illustrating an arrangement of components for directing attention of an occupant of an automotive vehicle to a viewport according to another aspect of the subject matter described herein;

FIG. 4b is a block diagram illustrating an arrangement of components for directing attention of an occupant of an automotive vehicle to a viewport according to another aspect of the subject matter described herein;

FIG. 5 is a network diagram illustrating an exemplary system for directing attention of an occupant of an automotive vehicle to a viewport according to another aspect of the subject matter described herein; and

FIG. 6 is a diagram illustrating a user interface presented to an occupant of an automotive vehicle in another aspect of the subject matter described herein.

### DETAILED DESCRIPTION

One or more aspects of the disclosure are described with reference to the drawings, wherein like reference numerals are generally utilized to refer to like elements throughout, and wherein the various structures are not necessarily drawn to scale. In the following description, for purposes of explanation, numerous specific details are set forth in order to provide a thorough understanding of one or more aspects of the disclosure. It may be evident, however, to one skilled in the art, that one or more aspects of the disclosure may be practiced with a lesser degree of these specific details. In other instances, well-known structures and devices are shown in block diagram form in order to facilitate describing one or more aspects of the disclosure.

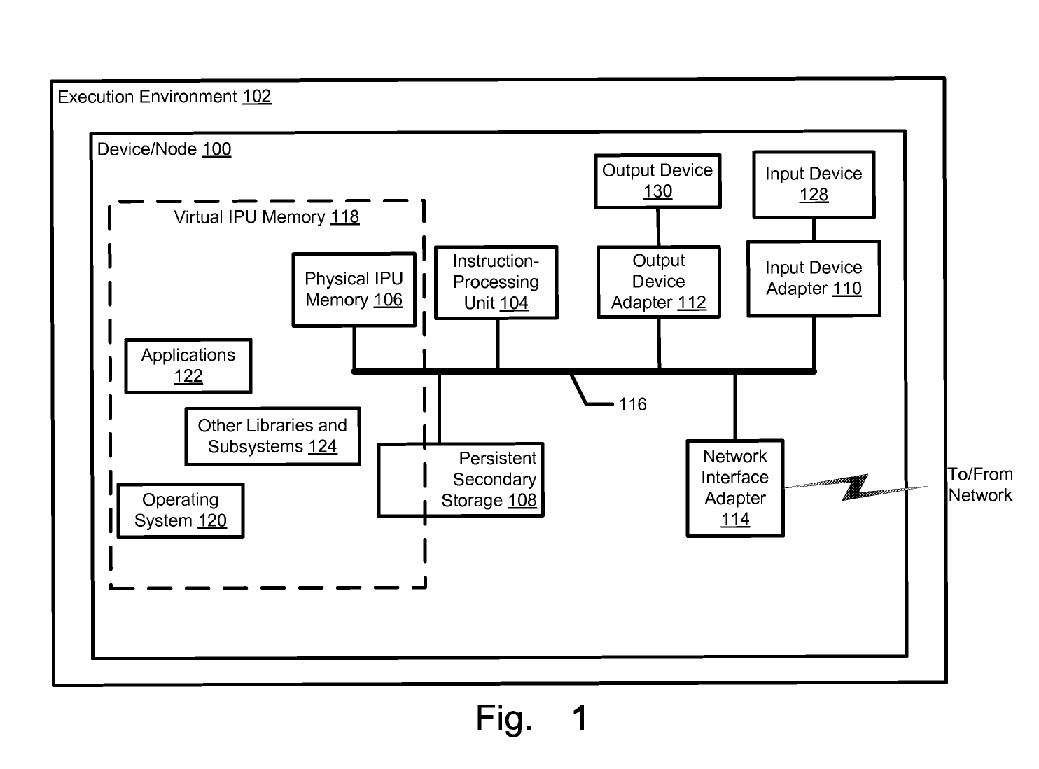

An exemplary device included in an execution environment that may be configured according to the subject matter is illustrated in FIG. 1. An execution environment includes an arrangement of hardware and, in some aspects, software that may be further configured to include an arrangement of components for performing a method of the subject matter described herein. An execution environment includes and/or is otherwise provided by one or more devices. An execution environment may include a virtual execution environment including software components operating in a host execution environment. Exemplary devices included in and/or otherwise providing suitable execution environments for configuring according to the subject matter include an automobile, a truck, a van, and/or sports utility vehicle. Alternatively or additionally a suitable execution environment may include and/or may be included in a personal computer, a notebook computer, a tablet computer, a server, a portable electronic device, a handheld electronic device, a mobile device, a multiprocessor device, a distributed system, a consumer electronic device, a router, a communication server, and/or any other suitable device. Those skilled in the art will understand that the components illustrated in FIG. 1 are exemplary and may vary by particular execution environment.

FIG. 1 illustrates hardware device 100 included in execution environment 102. FIG. 1 illustrates that execution environment 102 includes instruction-processing unit (IPU) 104, such as one or more microprocessors; physical IPU memory 106 including storage locations identified by addresses in a physical memory address space of IPU 104; persistent secondary storage 108, such as one or more hard drives and/or flash storage media; input device adapter 110, such as a key or keypad hardware, a keyboard adapter, and/or a mouse adapter; output device adapter 112, such as a display and/or an audio adapter for presenting information to a user; a network interface component, illustrated by network interface adapter 114, for communicating via a network such as a LAN and/or WAN; and a communication mechanism that couples elements 104-114, illustrated as bus 116. Elements 104-114 may be operatively coupled by various means. Bus 116 may comprise any type of bus architecture, including a memory bus, a peripheral bus, a local bus, and/or a switching fabric.

IPU 104 is an instruction execution machine, apparatus, or device. Exemplary IPUs include one or more microprocessors, digital signal processors (DSPs), graphics processing units, application-specific integrated circuits (ASICs), and/or field programmable gate arrays (FPGAs). In the description of the subject matter herein, the terms “IPU” and “processor” are used interchangeably. IPU 104 may access machine code instructions and data via one or more memory address spaces in addition to the physical memory address space. A memory address space includes addresses identifying locations in a processor memory. The addresses in a memory address space are included in defining a processor memory. IPU 104 may have more than one processor memory. Thus, IPU 104 may have more than one memory address space. IPU 104 may access a location in a processor memory by processing an address identifying the location. The processed address may be identified by an operand of a machine code instruction and/or may be identified by a register or other portion of IPU 104.

FIG. 1 illustrates virtual IPU memory 118 spanning at least part of physical IPU memory 106 and at least part of persistent secondary storage 108. Virtual memory addresses in a memory address space may be mapped to physical memory addresses identifying locations in physical IPU memory 106. An address space for identifying locations in a virtual processor memory is referred to as a virtual memory address space; its addresses are referred to as virtual memory addresses; and its IPU memory is referred to as a virtual IPU memory or virtual memory. The terms “IPU memory” and “processor memory” are used interchangeably herein. Processor memory may refer to physical processor memory, such as IPU memory 106, and/or may refer to virtual processor memory, such as virtual IPU memory 118, depending on the context in which the term is used.

Physical IPU memory 106 may include various types of memory technologies. Exemplary memory technologies include static random access memory (SRAM) and/or dynamic RAM (DRAM) including variants such as dual data rate synchronous DRAM (DDR SDRAM), error correcting code synchronous DRAM (ECC SDRAM), RAMBUS DRAM (RDRAM), and/or XDR™ DRAM. Physical IPU memory 106 may include volatile memory as illustrated in the previous sentence and/or may include nonvolatile memory such as nonvolatile flash RAM (NVRAM) and/or ROM.

Persistent secondary storage 108 may include one or more flash memory storage devices, one or more hard disk drives, one or more magnetic disk drives, and/or one or more optical disk drives. Persistent secondary storage may include a removable medium. The drives and their associated computer-readable storage media provide volatile and/or nonvolatile storage for computer-readable instructions, data structures, program components, and other data for execution environment 102.

Execution environment 102 may include software components stored in persistent secondary storage 108, in remote storage accessible via a network, and/or in a processor memory. FIG. 1 illustrates execution environment 102 including operating system 120, one or more applications 122, and other program code and/or data components illustrated by other libraries and subsystems 124. In an aspect, some or all software components may be stored in locations accessible to IPU 104 in a shared memory address space shared by the software components. The software components accessed via the shared memory address space are stored in a shared processor memory defined by the shared memory address space. In another aspect, a first software component may be stored in one or more locations accessed by IPU 104 in a first address space and a second software component may be stored in one or more locations accessed by IPU 104 in a second address space. The first software component is stored in a first processor memory defined by the first address space and the second software component is stored in a second processor memory defined by the second address space.

Software components typically include instructions executed by IPU 104 in a computing context referred to as a “process”. A process may include one or more “threads”. A “thread” includes a sequence of instructions executed by IPU 104 in a computing sub-context of a process. The terms “thread” and “process” may be used interchangeably herein when a process includes only one thread.

Execution environment 102 may receive user-provided information via one or more input devices illustrated by input device 128. Input device 128 provides input information to other components in execution environment 102 via input device adapter 110. Execution environment 102 may include an input device adapter for a keyboard, a touch screen, a microphone, a joystick, a television receiver, a video camera, a still camera, a document scanner, a fax, a phone, a modem, a network interface adapter, and/or a pointing device, to name a few exemplary input devices.

Input device 128 included in execution environment 102 may be included in device 100 as FIG. 1 illustrates or may be external (not shown) to device 100. Execution environment 102 may include one or more internal and/or external input devices. External input devices may be connected to device 100 via corresponding communication interfaces such as a serial port, a parallel port, and/or a universal serial bus (USB) port. Input device adapter 110 receives input and provides a representation to bus 116 to be received by IPU 104, physical IPU memory 106, and/or other components included in execution environment 102.

Output device 130 in FIG. 1 exemplifies one or more output devices that may be included in and/or that may be external to and operatively coupled to device 100. For example, output device 130 is illustrated connected to bus 116 via output device adapter 112. Output device 130 may be a display device. Exemplary display devices include liquid crystal displays (LCDs), light emitting diode (LED) displays, and projectors. Output device 130 presents output of execution environment 102 to one or more users. In some embodiments, an input device may also include an output device. Examples include a phone, a joystick, and/or a touch screen. In addition to various types of display devices, exemplary output devices include printers, speakers, tactile output devices such as motion-producing devices, and other output devices producing sensory information detectable by a user. Sensory information detected by a user is referred to as “sensory input” with respect to the user.

A device included in and/or otherwise providing an execution environment may operate in a networked environment communicating with one or more devices via one or more network interface components. The terms “communication interface component” and “network interface component” are used interchangeably herein. FIG. 1 illustrates network interface adapter (NIA) 114 as a network interface component included in execution environment 102 to operatively couple device 100 to a network. A network interface component includes a network interface hardware (NIH) component and optionally a software component.

Exemplary network interface components include network interface controller components, network interface cards, network interface adapters, and line cards. A node may include one or more network interface components to interoperate with a wired network and/or a wireless network. Exemplary wireless networks include a BLUETOOTH network, a wireless 802.11 network, and/or a wireless telephony network (e.g., a cellular, PCS, CDMA, and/or GSM network). Exemplary network interface components for wired networks include Ethernet adapters, Token-ring adapters, FDDI adapters, asynchronous transfer mode (ATM) adapters, and modems of various types. Exemplary wired and/or wireless networks include various types of LANs, WANs, and/or personal area networks (PANs). Exemplary networks also include intranets and internets such as the Internet.

The terms “network node” and “node” in this document both refer to a device having a network interface component for operatively coupling the device to a network. Further, the terms “device” and “node” used herein refer to one or more devices and nodes, respectively, providing and/or otherwise included in an execution environment unless clearly indicated otherwise.

The user-detectable outputs of a user interface are generically referred to herein as “user interface elements”. More specifically, visual outputs of a user interface are referred to herein as “visual interface elements”. A visual interface element may be a visual output of a graphical user interface (GUI). Exemplary visual interface elements include windows, textboxes, sliders, list boxes, drop-down lists, spinners, various types of menus, toolbars, ribbons, combo boxes, tree views, grid views, navigation tabs, scrollbars, labels, tooltips, text in various fonts, balloons, dialog boxes, and various types of button controls including check boxes and radio buttons. An application interface may include one or more of the elements listed. Those skilled in the art will understand that this list is not exhaustive. The terms “visual representation”, “visual output”, and “visual interface element” are used interchangeably in this document. Other types of user interface elements include audio outputs referred to as “audio interface elements”, tactile outputs referred to as “tactile interface elements”, and the like.

A visual output may be presented in a two-dimensional presentation where a location may be defined in a two-dimensional space having a vertical dimension and a horizontal dimension. A location in a horizontal dimension may be referenced according to an X-axis and a location in a vertical dimension may be referenced according to a Y-axis. In another aspect, a visual output may be presented in a three-dimensional presentation where a location may be defined in a three-dimensional space having a depth dimension in addition to a vertical dimension and a horizontal dimension. A location in a depth dimension may be identified according to a Z-axis. A visual output in a two-dimensional presentation may be presented as if a depth dimension existed allowing the visual output to overlie and/or underlie some or all of another visual output.

An order of visual outputs in a depth dimension is herein referred to as a “Z-order”. The term “Z-value” as used herein refers to a location in a Z-order. A Z-order specifies the front-to-back ordering of visual outputs in a presentation space. A visual output with a higher Z-value than another visual output may be defined to be on top of or closer to the front than the other visual output, in one aspect.

A “user interface (UI) element handler” component, as the term is used in this document, includes a component configured to send information representing a program entity for presenting a user-detectable representation of the program entity by an output device, such as a display. A “program entity” is an object included in and/or otherwise processed by an application or executable. The user-detectable representation is presented based on the sent information. Information that represents a program entity for presenting a user-detectable representation of the program entity by an output device is referred to herein as “presentation information”. Presentation information may include and/or may otherwise identify data in one or more formats. Exemplary formats include image formats such as JPEG, video formats such as MP4, markup language data such as hypertext markup language (HTML) and other XML-based markup, a bit map, and/or instructions such as those defined by various script languages, byte code, and/or machine code. For example, a web page received by a browser from a remote application provider may include HTML, ECMAScript, and/or byte code for presenting one or more user interface elements included in a user interface of the remote application. Components configured to send information representing one or more program entities for presenting particular types of output by particular types of output devices include visual interface element handler components, audio interface element handler components, tactile interface element handler components, and the like.

A representation of a program entity may be stored and/or otherwise maintained in a presentation space. As used in this document, the term “presentation space” refers to a storage region allocated and/or otherwise provided for storing presentation information, which may include audio, visual, tactile, and/or other sensory data for presentation by and/or on an output device. For example, a buffer for storing an image and/or text string may be a presentation space. A presentation space may be physically and/or logically contiguous or non-contiguous. A presentation space may have a virtual as well as a physical representation. A presentation space may include a storage location in a processor memory, secondary storage, a memory of an output adapter device, and/or a storage medium of an output device. A screen of a display, for example, is a presentation space.

As used herein, the term “program” or “executable” refers to any data representation that may be translated into a set of machine code instructions and optionally associated program data. Thus, a program or executable may include an application, a shared or non-shared library, and/or a system command. Program representations other than machine code include object code, byte code, and source code. Object code includes a set of instructions and/or data elements that either are prepared for linking prior to loading or are loaded into an execution environment. When in an execution environment, object code may include references resolved by a linker and/or may include one or more unresolved references. The context in which this term is used will make clear that state of the object code when it is relevant. This definition can include machine code and virtual machine code, such as Java™ byte code.

As used herein, an “addressable entity” is a portion of a program, specifiable in programming language in source code. An addressable entity is addressable in a program component translated for a compatible execution environment from the source code. Examples of addressable entities include variables, constants, functions, subroutines, procedures, modules, methods, classes, objects, code blocks, and labeled instructions. A code block includes one or more instructions in a given scope specified in a programming language. An addressable entity may include a value. In some places in this document “addressable entity” refers to a value of an addressable entity. In these cases, the context will clearly indicate that the value is being referenced.

Addressable entities may be written in and/or translated to a number of different programming languages and/or representation languages, respectively. An addressable entity may be specified in and/or translated into source code, object code, machine code, byte code, and/or any intermediate languages for processing by an interpreter, compiler, linker, loader, and/or other analogous tool.

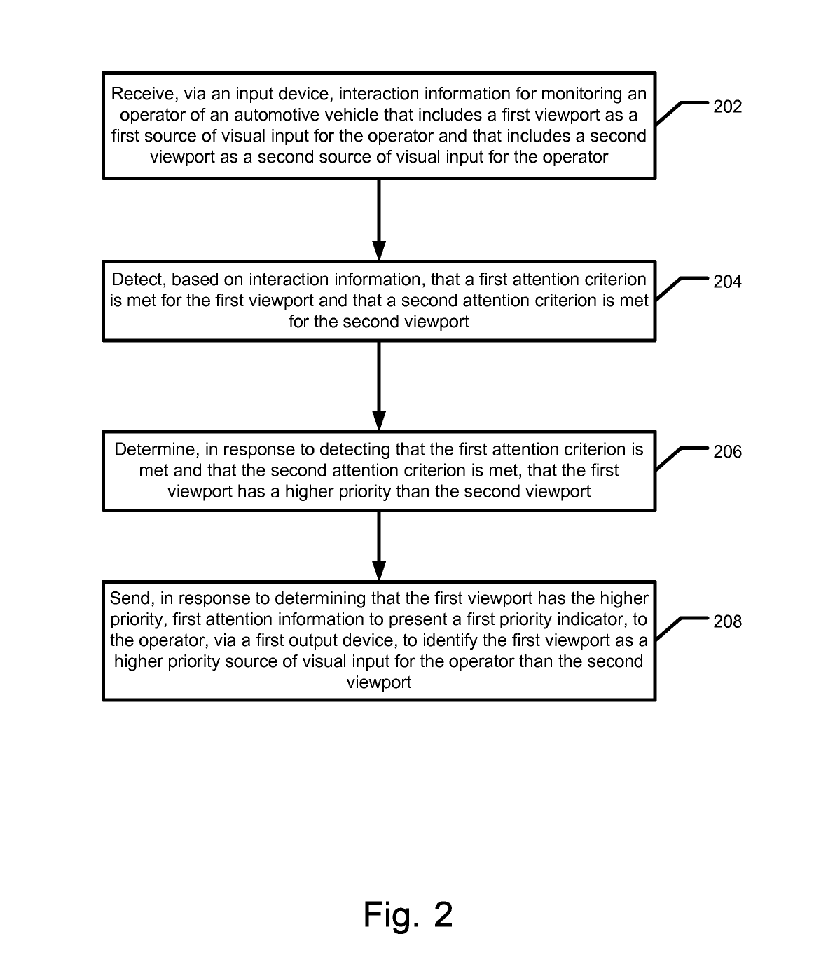

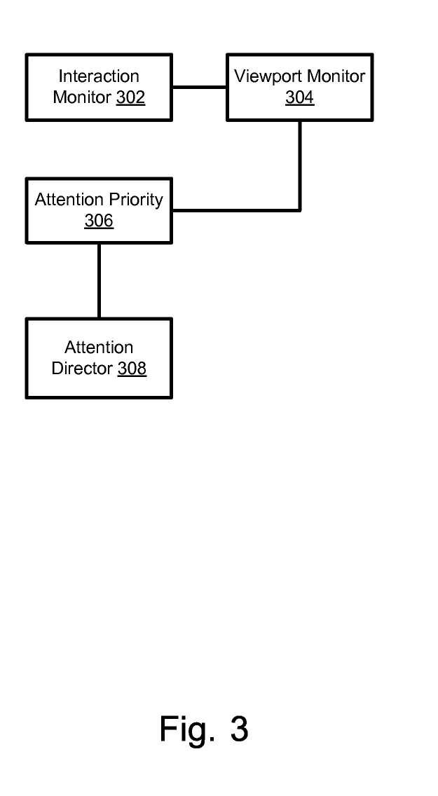

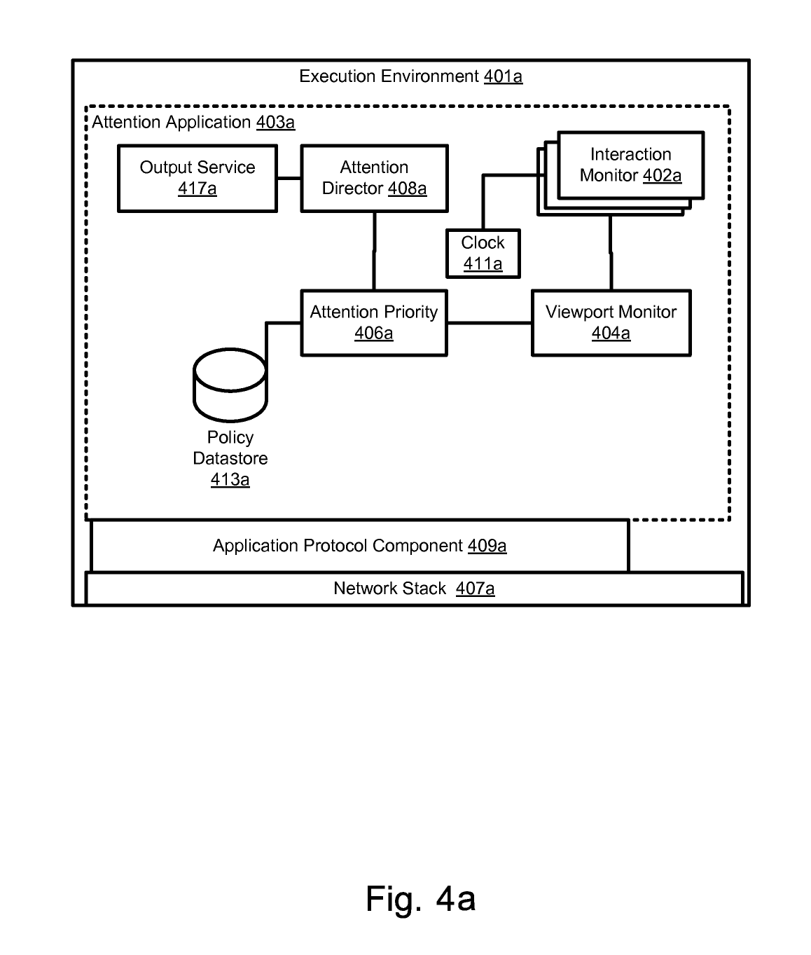

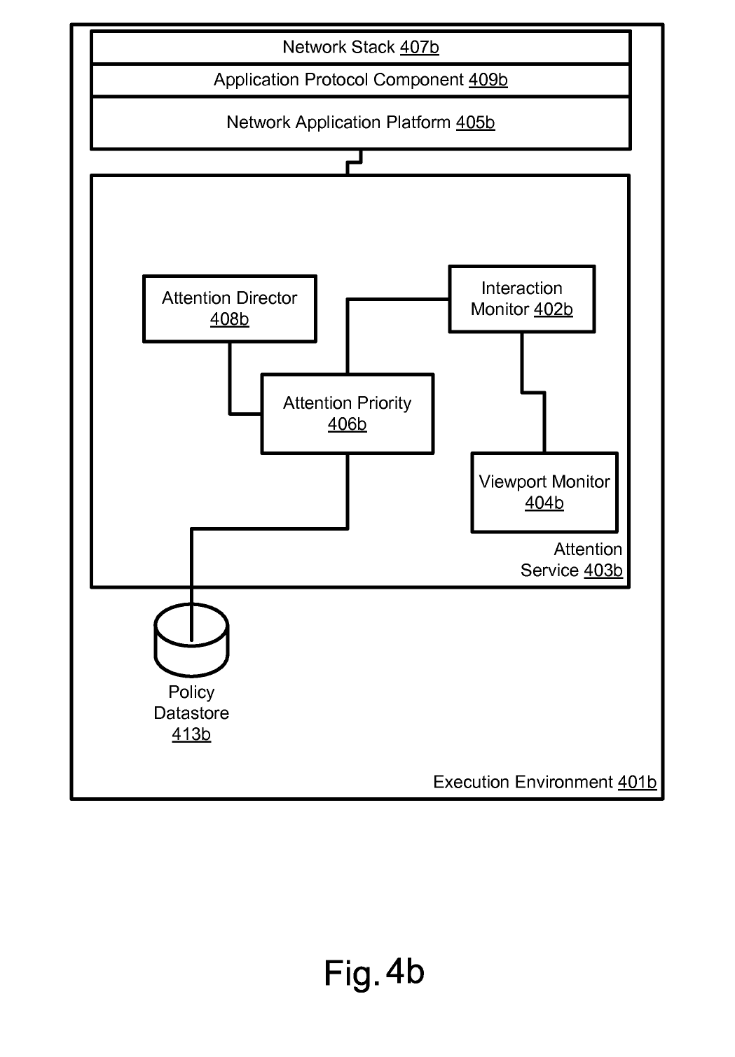

The block diagram in FIG. 3 illustrates an exemplary system for directing attention of an occupant of an automotive vehicle to a viewport according to the method illustrated in FIG. 2. FIG. 3 illustrates a system, adapted for operation in an execution environment, such as execution environment 102 in FIG. 1, for performing the method illustrated in FIG. 2. The system illustrated includes an interaction monitor component 302, a viewport monitor component 304, an attention priority component 306, and an attention director component 308. The execution environment includes an instruction-processing unit, such as IPU 104, for processing an instruction in at least one of the interaction monitor component 302, the viewport monitor component 304, the attention priority component 306, and the attention director component 308. Some or all of the exemplary components illustrated in FIG. 3 may be adapted for performing the method illustrated in FIG. 2 in a number of execution environments. FIGS. 4a-b are each block diagrams illustrating the components of FIG. 3 and/or analogs of the components of FIG. 3 respectively adapted for operation in execution environments 401 that include or that otherwise are provided by one or more nodes. Components, illustrated in FIG. 4a and FIG. 4b, are identified by numbers with an alphabetic character postfix. Execution environments; such as execution environment 401a, execution environment 401b, and their adaptations and analogs; are referred to herein generically as execution environment 401 or execution environments 401 when describing more than one. Other components identified with an alphabetic postfix may be referred to generically or as a group in a similar manner.

FIG. 1 illustrates key components of an exemplary device that may at least partially provide and/or otherwise be included in an execution environment. The components illustrated in FIG. 4a and FIG. 4b may be included in or otherwise combined with the components of FIG. 1 to create a variety of arrangements of components according to the subject matter described herein.

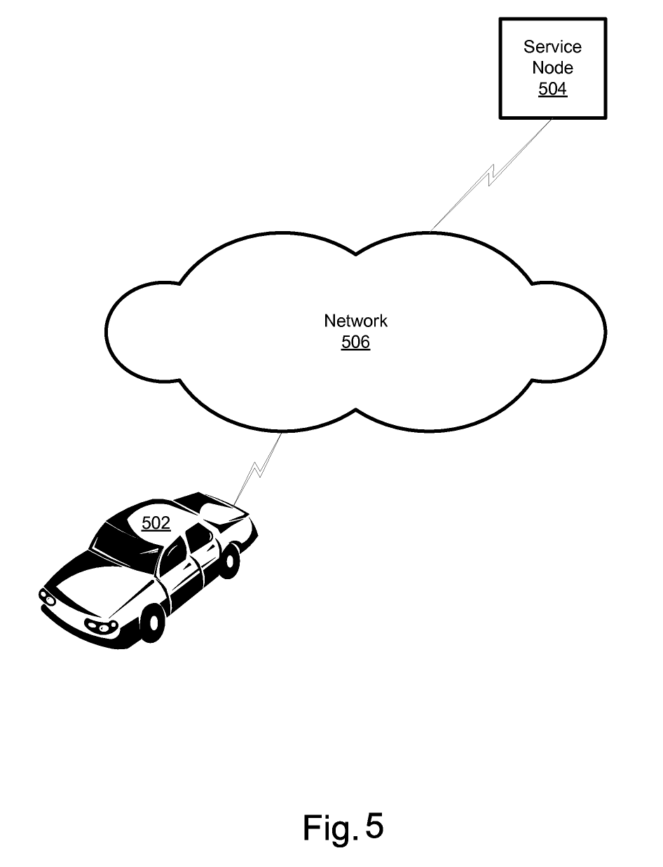

In an aspect, execution environment 401a may be included in an automotive vehicle. In FIG. 5, automotive vehicle 502 may include and/or otherwise provide an instance of execution environment 401a or an analog. FIG. 4b illustrates execution environment 401b configured to host a network accessible application illustrated by safety service 403b. Attention service 403b includes another adaptation or analog of the arrangement of components in FIG. 3. In an aspect, execution environment 401b may include and/or otherwise be provided by service node 504 illustrated in FIG. 5.

Adaptations and/or analogs of the components illustrated in FIG. 3 may be installed persistently in an execution environment while other adaptations and analogs may be retrieved and/or otherwise received as needed via a network. In an aspect, some or all of the arrangement of components operating in an execution environment of automotive vehicle 502 may be received via network 506. For example, service node 504 may provide some or all of the components.

An arrangement of components for performing the method illustrated in FIG. 2 may operate in a particular execution environment, in one aspect, and may be distributed across more than one execution environment, in another aspect. Various adaptations of the arrangement in FIG. 3 may operate at least partially in an execution environment in automotive vehicle 502 and/or at least partially in the execution environment in service node 504.

As stated the various adaptations of the arrangement in FIG. 3 are not exhaustive. For example, those skilled in the art will see based on the description herein that arrangements of components for performing the method illustrated in FIG. 2 may operate in an automotive vehicle or may be distributed across more than one node in a network including some or all of an automotive vehicle, and/or may be distributed across more than one execution environment.

As described above, FIG. 5 illustrates automotive vehicle 502. An automotive vehicle may include a gas powered, oil powered, bio-fuel powered, solar powered, hydrogen powered, and/or electricity powered car, truck, van, bus, or the like. In an aspect, automotive vehicle 502 may communicate with one or more application providers, also referred to as service providers, via a network, illustrated by network 506 in FIG. 5. Service node 504 illustrates one such application provider. Automotive vehicle 502 may communicate with network application platform 405b in FIG. 4b operating in execution environment 401b included in and/or otherwise provided by service node 504 in FIG. 5. Automotive vehicle 502 and service node 504 may each include a network interface component operatively coupling each respective node to network 506.

FIGS. 4a-b illustrate network stacks 407 configured for sending and receiving data over a network 506. Network application platform 405b in FIG. 4b may provide one or more services to attention service 403b. For example, network application platform 405b may include and/or otherwise provide web server functionally on behalf of attention service 403b. FIG. 4b also illustrates network application platform 405b configured for interoperating with network stack 407b providing network services for attention service 403b. Network stack 407a in FIG. 4a serves a role analogous to network stack 407b operating in various adaptations of execution environment 401b.

Network stack 407a and network stack 407b may support the same protocol suite, such as TCP/IP, or may communicate via a network gateway (not shown) or other protocol translation device (not shown) and/or service (not shown). For example, automotive vehicle 502 and service node 504 in FIG. 5 may interoperate via their respective network stacks: network stack 407a in FIG. 4a and network stack 407b in FIG. 4b.

FIG. 4a illustrates attention application 403a; and FIG. 4b illustrates attention service 403b, respectively, which may communicate via one or more application protocols. FIGS. 4a-b illustrate application protocol components 409 configured to communicate via one or more specified application protocols. Exemplary application protocols include a hypertext transfer protocol (HTTP), a remote procedure call protocol (RPC), an instant messaging protocol, and a presence protocol. Application protocol components 409 in FIGS. 4a-b may provide support for compatible application protocols. Matching protocols enable attention application 403a in automotive vehicle 502 to communicate with attention service 403b of service node 504 via network 506 in FIG. 5. Matching protocols are not required if communication is via a protocol gateway or other translator.

In FIG. 4a, attention application 403a may receive some or all of the arrangement of components in FIG. 4a in one more messages received via network 506 from another node. In an aspect, the one or more message may be sent by attention service 403b via network application platform 405b, network stack 407b, a network interface component, and/or application protocol component 409b in execution environment 401b. Attention application 403a may interoperate via one or more of the application protocols provided by application protocol component 409a and/or via a protocol supported by network stack 407a to receive the message or messages including some or all of the components and/or their analogs adapted for operation in execution environment 401a.

An “interaction”, as the term is used herein, refers to any activity including a user and an object where the object is a source of sensory input detected by the user. In an interaction the user directs attention to the object. An interaction may also include the object as a target of input from the user. The input may be provided intentionally or unintentionally by the user. For example, a rock being held in the hand of a user is a target of input, both tactile and energy input, from the user. A portable electronic device is a type of object. In another example, a user looking at a portable electronic device is receiving sensory input from the portable electronic device whether the device is presenting an output via an output device or not. The user manipulating an input component of the portable electronic device exemplifies the device, as an input target, receiving input from the user. Note that the user in providing input is detecting sensory information from the portable electronic device provided that the user directs sufficient attention to be aware of the sensory information and provided that no disabilities prevent the user from processing the sensory information. An interaction may include an input from the user that is detected and/or otherwise sensed by the device. An interaction may include sensory information that is detected by a user that is included in the interaction and presented by an output device that is included in the interaction.

As used herein “interaction information” refers to any information that identifies an interaction and/or otherwise provides data about an interaction between a user and an object, such as a personal electronic device. Exemplary interaction information may identify a user input for the object, a user-detectable output presented by an output device of the object, a user-detectable attribute of the object, an operation performed by the object in response to a user, an operation performed by the object to present and/or otherwise produce a user-detectable output, and/or a measure of interaction.

The term “occupant” as used herein refers to a passenger of an automotive vehicle. An operator of an automotive vehicle is an occupant of the automotive vehicle. As the terms are used herein, an “operator” of an automotive vehicle and a “driver” of an automotive vehicle are equivalent.

Interaction information for one viewport may include and/or otherwise identify interaction information for another viewport and/or other object. For example, a motion detector may detect an operator's head turn in the direction of a windshield of automotive vehicle 502 in FIG. 5. Interaction information identifying the operator's head is facing the windshield may be received and/or used as interaction information for the windshield indicating the operator's is receiving visual input from a viewport provided by some or all of the windshield. The interaction information may serve to indicate a lack of operator interaction with one or more other viewports such as a rear window of the automotive vehicle. Thus the interaction information may serve as interaction information for one or more viewports

The term “viewport” as used herein refers to any opening and/or surface of an automobile that provides a view of a space outside the automotive vehicle. A window, a screen of a display device, a projection from a projection device, and a mirror are all viewports and/or otherwise included in a viewport. A view provided by a viewport may include an object external to the automotive vehicle visible to the operator and/other occupant. The external object may be an external portion of the automotive vehicle or may be an object that is not part of the automotive vehicle.

With reference to FIG. 2, block 202 illustrates that the method includes receiving, via an input device, interaction information for monitoring an operator of an automotive vehicle that includes a first viewport as a first source of visual input for the operator and that includes a second viewport as a second source of visual input for the operator. Accordingly, a system for directing attention of an occupant of an automotive vehicle to a viewport includes means for receiving, via an input device, interaction information for monitoring an operator of an automotive vehicle that includes a first viewport as a first source of visual input for the operator and that includes a second viewport as a second source of visual input for the operator. For example, as illustrated in FIG. 3, interaction monitor component 302 is configured for receiving, via an input device, interaction information for monitoring an operator of an automotive vehicle that includes a first viewport as a first source of visual input for the operator and that includes a second viewport as a second source of visual input for the operator. FIGS. 4a-b illustrate interaction monitor components 402 as adaptations and/or analogs of interaction monitor component 302 in FIG. 3. One or more interaction monitor components 402 operate in an execution environment 401.

In FIG. 4a, interaction monitor component 402a is illustrated as a component of attention application 403a. In FIG. 4b, interaction monitor component 402b is illustrated as component of attention service 403b. In various aspects, adaptations and analogs of interaction monitor component 302 in FIG. 3 may monitor an operator, another occupant of an automotive vehicle, and/or an object by receiving interaction information for one or more viewports including and/or otherwise providing views viewable to the operator and/or other occupant(s). Interaction information may be based on a sensed and/or otherwise monitored input received by an input device.

Interaction information may be based on any input and/or group of inputs for detecting and/or otherwise determining whether an attention criterion is met for a viewport. As used herein the term “attention criterion” refers to a criterion that when met is defined as indicating that interaction between an operator and a viewport is or maybe inadequate at a particular time and/or during a particular time period. In other words, the operator is not directing adequate attention to the viewport or other object.

In an aspect, interaction information for a particular viewport may be received based on a lack of input detected by an input device. For example, a gaze detector for detecting input for a left, front window of an automotive vehicle may not detect the gaze of the operator of the automotive vehicle at a particular time and/or during a time period. Interaction information indicating the left, front window has not been viewed by the operator at the particular time and/or during the particular time period may be received by interaction monitor component 402a in FIG. 4a from the gaze detector.

Interaction monitor components 402 in FIG. 4a and/or in FIG. 4b may include and/or otherwise interoperate with a variety of input devices. In an aspect, input from a user may be received via a radio dial included in automotive vehicle 502, The user may be the operator of automotive vehicle 502. Interaction information based on the input may indicate, to an interaction monitor component 402, a spatial direction of the operator's attention relative to a particular viewport providing a view, such as a window to the left of the operator. Interaction monitor component 402a may receive interaction information in response to the detected radio dial input indicating a physical movement of the driver of automotive vehicle 502. Input received via other input controls may result in interaction information detectable by an interaction monitor 402. Exemplary input controls include buttons, switches, levers, toggles, sliders, lids, door handles, and seat adjustment controls.

Alternatively or additionally, an interaction monitor component 402 in FIG. 4a and/or in FIG. 4b may detect and/or otherwise receive interaction information identifying a measure of interaction, determined based on a specified interaction metric. The measure of interaction may indicate a degree or level of interaction between an operator and viewport. For example, a sensor in a headrest in automotive vehicle 502 may detect an operator's head contacting the headrest. The sensor may detect a duration of contact with the headrest, a measure of pressure received by the headrest from the contact, a number of contacts in a specified period of time, and/or a pattern of contacts detected over a period of time. The sensor in the headrest may include interaction monitor component 402a, may be included in interaction monitor component 402a, and/or may be operatively coupled to interaction monitor component 402a and/or interaction monitor component 402b. Interaction information received by and/or from the sensor in the headrest may identify and/or may be included in determining a measure of interaction, according to a specified metric measuring interaction of an operator and/or other occupant with a viewport.

An interaction monitor component 402 may detect and/or otherwise receive interaction information based on other parts of an operator and/or other occupant's body. Interaction information may be received by interaction monitor component 402a and/or interaction monitor component 402b based on an eye, an eyelid, a head, a chest, an abdomen, a back, a leg, a foot, a toe, an arm, a hand, a finger, a neck, skin, and/or hair; and/or portion of an operator and/or another occupant's body that is monitored. An interaction monitor component 402 may detect and/or otherwise receive interaction information identifying, for a part or all of an operator and/or other occupant, a direction of movement, a distance of movement, a pattern of movement, and/or a count of movements.

In an aspect, a gaze detector included in automotive vehicle 502 may detect a driver's eye movements to determine a direction of focus and/or a level of focus directed towards a particular viewport providing a view and/or away from another viewport. Interaction monitor component 402a in FIG. 4a may include and/or otherwise be operatively coupled to the gaze detector. One or more gaze detectors may be included in one or more locations in automotive vehicle 502 for detecting interaction with a windshield of automotive vehicle 502, a side window, a mirror, a display, a sun/moon roof, and/or a rear window. Alternatively or additionally, one or more gaze detectors may be included in automotive vehicle 502 to monitor interaction with something other than a viewport of automotive vehicle 502. For example, a gaze detector may detect visual interaction with a radio, a glove box, a heating and ventilation control, and/or with another occupant. In another aspect, a gaze detector in automotive vehicle 502 may be communicatively coupled to interaction monitor component 402b operating in service node 504 via network 506.

An interaction monitor component 402 in FIG. 4a and/or in FIG. 4b may receive interaction information for a viewport in automotive vehicle 502, such as a screen of display device providing a view of an outside space, by monitoring an operator's interaction with some other viewport and/or object. Interaction monitor component 402a may receive interaction information for a first viewport, such as a rear window providing a view, by monitoring interaction with a second viewport and/or other object in automotive vehicle 502, such as a windshield or front window, providing another view viewable by the operator and/or other occupant of automotive vehicle 502. A gaze detector and/or motion sensing device may be at least partially included in automotive vehicle 502, and/or at least partially on and/or in an operator and/or other occupant of automotive vehicle 502. For example, an operator may wear eye glasses and/or other gear that includes a motion sensing device detecting direction and/or patterns of movement of a head and/or eye of the operator.

Alternatively or additionally, interaction monitor component 402 in FIG. 4a and/or in FIG. 4b may include and/or otherwise may communicate with other attention sensing devices. Various interaction monitor components may interoperate with various types of head motion sensing devices included in respective automotive vehicles and/or worn by operators and/or other occupants. Parts of automotive vehicle 502 may detect touch input directly and/or indirectly including depressible buttons, rotatable dials, multi-position switches, and/or touch screens. A seat may be included that detects body direction and/or movement. A headrest may detect contact and thus indicate a head direction and/or level of interaction of an operator and/or other occupant. Automotive vehicle 502 may include one or more microphones for detecting sound and determining a direction of a head of operator and/or other occupant. Other sensing devices that may be included in automotive vehicle, included in an operator and/or other occupant, and/or attached to an operator and/or other occupant include galvanic skin detectors, breath analyzers, detectors of bodily emissions, and detectors of substances taken in by an operator and/or other occupant such as alcohol.

FIG. 4b illustrates interaction monitor component 402b operating external to an automotive vehicle. Interaction monitor component 402b operating in service node 504 may receive interaction information for an operator and/or other occupant of automotive vehicle 502 via network 506. Interaction monitor component 402b in FIG. 4b may receive interaction information from one or more of the exemplary sensing devices described above with respect to FIG. 4a. Interaction monitor component in 402b operating in service node 504 may interoperate with one or more automotive vehicles. In an aspect, interaction monitor component 402b may receive interaction information for a first operator and/or other occupant in a first automotive vehicle with a first viewport providing a view of a second automotive vehicle. Interaction monitor component 402b may similarly receive interaction information for a second operator and/or other occupant in the second automotive vehicle for a second viewport providing a second view of the first automotive vehicle. Thus, interaction monitor component 402b along with other components in the arrangement in FIG. 4b may manage interaction of one or more operators and/or other occupants in a group of automotive vehicles in a coordinated manner.

Returning to FIG. 2, block 204 illustrates that the method further includes detecting, based on the interaction information, that a first attention criterion is met for the first viewport and that a second attention criterion is met for the second viewport. Accordingly, a system for directing attention of an occupant of an automotive vehicle to a viewport includes means for detecting, based on the interaction information, that a first attention criterion is met for the first viewport and that a second attention criterion is met for the second viewport. For example, as illustrated in FIG. 3, viewport monitor component 304 is configured for detecting, based on the interaction information, that a first attention criterion is met for the first viewport and that a second attention criterion is met for the second viewport. FIGS. 4a-b illustrate viewport monitor components 404 as adaptations and/or analogs of viewport monitor component 304 in FIG. 3. One or more viewport monitor components 404 operate in execution environments 401.

Interaction information may be received by one or more viewport monitor components 404 in an execution environment 401, illustrated in FIG. 4a and in FIG. 4b, to detect whether an attention criterion is met for a viewport.

In an aspect, a viewport monitor component 404 in FIG. 4a and/or in FIG. 4b may determine that an attention criterion is met for a first viewport, in response to determining whether an attention criterion is met for a second viewport. An attention criterion may be specified based on a measure of interaction. An attention criterion may be preconfigured for evaluation for a particular viewport or may be associated with the viewport dynamically. Different viewports may be associated with different attention criteria. In another aspect, an attention criterion may be associated with more than one viewport. Different attention criteria may be based on a same measure of interaction and/or metric for determining a measure of interaction. In another aspect different attention criteria may be based on different measures of interaction and/or different metrics. A measure and/or metric for determining whether an attention criterion is met may be pre-configured and/or may be determined dynamically based on any information detectable within an execution environment hosting some or all of an adaptation and/or analog of the arrangement of components in FIG. 3.

In various aspects, whether an attention criterion is met or not for a viewport may be based on an attribute of the viewport, an attribute of another viewport, an attribute of a view provided by a viewport of an automotive vehicle, an operator of an automotive vehicle, an attribute of one or more occupants of an automotive vehicle, an attribute of movement of an automotive vehicle, a location of an automotive vehicle, and/or an ambient condition in and/or outside an automotive vehicle, to name a few examples. Predefined and/or dynamically determined values may be included in determining whether an attention criterion for a viewport is met or not. For example, one or more of a velocity of an automotive vehicle, a rate of acceleration, a measure of outside light, a traffic level, and/or an age of an operator of an automotive vehicle may be included in determining whether an attention criterion for a viewport is met.

In an aspect, an attention criterion may identify a threshold based on a metric for measuring interaction. When a measure of interaction is determined to have crossed the identified threshold, the attention criterion may be defined as met.

Viewport monitor component 404a in FIG. 4a and/or viewport monitor component 404b in FIG. 4b may interoperate with a timer component, such as clock component 411a, in FIG. 4a, to set a timer at a particular time with a given duration. The particular time may be identified by configuration information. For example, a timer may be set at regular intervals and/or in response to one or more specified events such as a change in speed and/or direction of automotive vehicle 502. In an aspect, a timer may be set in response to receiving interaction information. For example, interaction monitor component 402a may detect visual interaction between an operator and a front windshield of automotive vehicle 502. In response, viewport monitor component 404a, interoperating with interaction monitor component 402a, may instruct clock component 411a to start a timer for detecting whether an attention criterion met for a rear-view mirror.

In various aspects, adaptations and analogs of viewport monitor component 304 may detect an expiration of a timer as indicating an attention criterion is met. In other aspect, an expiration of timer may indicate that an attention criterion is not met. Thus, an attention criterion may be based on time. A time period may be detected indirectly through detecting the occurrence of other events that bound and/or otherwise identify a start and/or an end of a time period. Time periods may have fixed and/or may have varying durations.

In various aspects, various measures of time and various components for measuring time may be included in and/or operatively coupled to the respective adaptations and analogs of viewport monitor component 304 in FIG. 3. Time may be measured in regular increments as is typical in everyday life, but may also be measured by the occurrence of events that may be occur irregularly over a given period as compared to the regularity of, for example, a processor clock. For example, time may be measured in distance traveled by automotive vehicle 502, a measure of time may be based on a velocity of automotive vehicle 502, input events detected by one or more components of automotive vehicle 502, and/or time may be measured in terms of detected objects external to automotive vehicle 502 such as another moving automotive vehicle.

In another aspect, determining whether an attention criterion is met may include detecting a specified time period indicating that the attention criterion is to be tested. For example, a timer may be set to expire every thirty seconds to indicate that an attention criterion for a side-view mirror is to be tested. In another example, a start of a time period may be detected in response to interaction monitor component 402b receiving interaction information including a first indicator of visual attention. An end of the time period may be detected in response to interaction monitor component 402b receiving interaction information including a subsequent indicator of visual attention. Viewport monitor component 404b may measure a duration of the time period based on interaction monitor component 402b receiving the first indicator and the subsequent indicator.

Alternatively or additionally, determining whether an attention criterion is met or not may include detecting a time period during which no input is detected that would indicate an operator is interacting with a specified viewport for at least a portion of the time period. The time period and/or portion thereof may be defined by a configuration of a particular viewport monitor component 404. For example, a time period may be defined based on detecting that a particular number of indicators of visual interaction have been received and/or may be defined based on a measure of time between receiving indicators of visual interaction in the time period.

Alternatively or additionally, detecting that an attention criterion is met may include detecting interaction with something other than the viewport for at least a portion of the time period. As similarly described in the previous paragraph, the time period and/or portion thereof may be defined by a configuration of a particular interaction monitor component 402. A time period or portion thereof, of interaction with the other thing, may be defined based on detecting a particular number of indicators of visual interaction received in the time period and/or the portion based on a measure of time between receiving indicators of visual interaction.

In various aspects, adaptations and analogs of viewport monitor component 304 in FIG. 3 may receive and/or otherwise evaluate an attention criterion. An attention criterion may be tested and/or otherwise detected based on a duration of a detected time period. That is the attention criterion may be time-based. An attention criterion may be selected and/or otherwise identified from multiple attention criteria for testing based on a duration of a detected time period.

A measure of the duration of a time period may be provided as input for testing and/or otherwise evaluating an attention criterion by viewport monitor component 404a in FIG. 4a and/or viewport monitor component 404b in FIG. 4b. A variety of criteria may be tested in various aspects. An attention criterion may specify a threshold length for a duration for testing to determine whether the duration detected matches and/or otherwise meets the threshold criterion. A threshold in an attention criterion may be conditional. That is, the threshold may be based on a view, an object visible in a view, a particular occupant, a speed of an automotive vehicle, another vehicle, a geospatial location of automotive vehicle 502, a current time, a day, a month, and/or an ambient condition, to name a few examples.

An attention criterion may be evaluated relative to another attention criterion. In FIG. 4a, viewport monitor component 404a may test a first attention criterion for a first view that includes a comparison including an attention criterion for a second viewport. In FIG. 4b, viewport monitor component 404b may detect a first attention criterion is met for a first viewport when a second attention criterion for a second viewport is not met. For example, the second viewport may include some or all of the windshield of automotive vehicle 502 and the first viewport include some or all of a mirror of automotive vehicle 502.

Viewport monitor component 404a may receive and/or identify a measure of interaction based on a first duration of a first time period. For example, viewport monitor component 404a may determine a ratio of the first duration to a second duration in a second time period. An attention criterion for a side-view mirror may specify that the attention criterion is met when the ratio of a first measure of interaction, based on a duration of a first time period for the side-view mirror, to a second measure of interaction, based on a duration of a second time period for a rear-view mirror, is at least two or some other specified value.

In a further aspect, an attention criterion may be evaluated based on detecting the occurrence of one or more particular events. For example viewport monitor component 404b in FIG. 4b may evaluate an attention criterion for a rear window of automotive vehicle 502. The attention criterion for the rear window may specify that the criterion is met only when automotive vehicle is moving in a reverse direction and/or otherwise is in a reverse gear.

Returning to FIG. 2, block 206 illustrates that the method yet further includes determining, in response to detecting that the first attention criterion is met and that the second attention criterion is met, that the first viewport has a higher priority than the second viewport. Accordingly, a system for directing attention of an occupant of an automotive vehicle to a viewport includes means for determining, in response to detecting that the first attention criterion is met and that the second attention criterion is met, that the first viewport has a higher priority than the second viewport. For example, as illustrated in FIG. 3, attention priority component 306 is configured for determining, in response to detecting that the first attention criterion is met and that the second attention criterion is met, that the first viewport has a higher priority than the second viewport. FIGS. 4a-b illustrate attention priority components 406 as adaptations and/or analogs of attention priority component 306 in FIG. 3. One or more attention priority components 406 operate in execution environments 401.

In various aspects, adaptations and analogs of attention priority component 306 in FIG. 3 may receive and/or otherwise identify a priority criterion for determining that a viewport, for which an attention criterion is met, has a higher priority than one or more other viewports that have respective, met attention criteria. A priority criterion may be evaluated by an attention priority component 406 to determine an order between and/or among the viewports to determine that a first viewport has a higher attention priority than a second viewport both having a met attention criterion. A priority criterion may be based on a length of time that an attention criterion has been met and/or a length of time since an attention criterion was determined to be met. The viewport having the longest time period may have a higher priority than the other viewport, in an aspect. In another aspect, a first viewport having a met first attention criterion may have a higher priority than a second viewport with a met second attention criterion even though the first attention criterion is based on a shorter length of time than and/or is based on a priority criterion that is not based on a measure of a length of time.

In another aspect, a priority criterion for identifying a higher priority viewport between/among multiple viewports may be based on one or more of the attention criteria corresponding to the respective viewports. For example, an attention criterion for a first viewport may be based on a speed that the automotive vehicle including the first viewport is approaching an object visible in the first viewport and a distance between the automotive vehicle and the object. An attention criterion for a second viewport in the automotive vehicle may be based on a length of time since interaction with the operator was detected with the second viewport. The first viewport may be a front windshield and the second viewport may be mirror. An attention priority component 406 may be configured to assign a higher priority to a viewport providing a view of an object becoming closer to automotive vehicle 502 than a viewport that does not include an object becoming closer regardless of any length of time that an attention criterion has been met and/or regardless of any length of time since the attention criterion was detected as met. A priority criterion may be selected and/or otherwise identified from multiple priority criteria for determining a priority for viewport. The selection of a priority criterion for determining a priority of a viewport may be predefined or may be determined dynamically based on a configuration of a particular attention priority component 406.

In still another aspect, a priority of a viewport may be determined independent of the attention criterion met for the viewport, aside from its detection. For example, a viewport including the windshield of a may be defined to always be a higher priority viewport than a left side mirror when both have corresponding detected attention criteria.

Viewport priorities may be based on respective lengths of time since interaction information was last received indicating operator interaction with the respective viewports. A priority criterion may be coded into an attention priority component 406 and/or may be received as configuration information by the attention priority component 406. A variety of priority criterion may be tested and/or evaluated in various aspects in determining respective priorities for multiple viewports having respective attention criteria.

A priority criterion evaluated for determining a viewport's priority may be based on an object visible in a view, a particular occupant, a speed of an automotive vehicle, a geospatial location of automotive vehicle 502, a current time, a day, a month, and/or an ambient condition, to name a few examples. For example, a priority criterion may be based on a location of viewports, having met attention criteria, with respect to a direction of movement of automotive vehicle 502 that includes the viewports. In FIG. 4b, attention priority component 406b may determine that a first viewport is a higher priority viewport than a second viewport. The second viewport may be and/or may include a mirror of automotive vehicle 502 and the first viewport may be and/or may include a windshield of automotive vehicle 502. In an aspect, when an attention criterion is met for the second viewport and an attention criterion is met for the first viewport, the second viewport may be identified as the higher priority viewport over the first viewport when another vehicle is visible in the second viewport and no vehicle is visible in the first viewport. If a vehicle is visible in both viewports another priority criterion may be selected by attention priority component 406b for determining the higher priority viewport.

In another aspect, attention priority component 406a may determine a ratio of a length of time associated with a first attention criterion to a length of time associated with a second attention criterion. A priority criterion may specify that a side-view mirror is a higher priority viewport with respect to second viewport when the ratio of the first length to the second length meets a threshold criterion. For example, the threshold criterion may specify that the ratio must be 2 or greater.

Returning to FIG. 2, block 208 illustrates that the method yet further includes sending, in response to determining that the first viewport has the higher priority, first attention information to present a first priority indicator, to the operator, via a first output device, to identify the first viewport as a higher priority source of visual input for the operator than the second viewport. Accordingly, a system for directing attention of an occupant of an automotive vehicle to a viewport includes means for sending, in response to determining that the first viewport has the higher priority, first attention information to present a first priority indicator, to the operator, via a first output device, to identify the first viewport as a higher priority source of visual input for the operator than the second viewport. For example, as illustrated in FIG. 3, attention director component 308 is configured for sending, in response to determining that the first viewport has the higher priority, first attention information to present a first priority indicator, to the operator, via a first output device, to identify the first viewport as a higher priority source of visual input for the operator than the second viewport. FIGS. 4a-b illustrate attention director components 408 as adaptations and/or analogs of attention director component 308 in FIG. 3. One or more attention director components 408 operate in execution environments 401.

The term “attention information” as used herein refers to information that identifies a priority indicator and/or that includes an indication to present a priority indicator output. Attention information may identify and/or may include presentation information that includes a representation of a priority indicator, in one aspect. In another aspect, attention information may include a request and/or one or more instructions for processing by an IPU to present a priority indicator.

Attention information for presenting a user-detectable output as a priority indicator identifying a viewport as having higher priority than another viewport may be sent via any suitable mechanism including an invocation mechanism, such as a function and/or method call utilizing a stack frame; an interprocess communication mechanism, such as a pipe, a semaphore, a shared data area, and/or a message queue; a register of a hardware component, such as an IPU register; a hardware bus, and/or a network communication, such as an HTTP request and/or an asynchronous message. A priority indicator may be presented to cause interaction between an operator and a particular viewport.

In FIG. 4a, attention director component 408a may include a UI element handler component (not shown) for presenting a priority indicator to attract, instruct, and/or otherwise direct attention from an operator and/or other occupant of automotive vehicle 502 to a viewport. A priority indicator that is presented to attract, instruct, and/or otherwise direct attention of an operator and/or other occupant to a first viewport prior to a second viewport is referred to herein as a “higher priority indicator” with a priority indicator for the second viewport. The priority indicator for the second viewport may be presented while and/or after the higher priority indicator for the first viewport.

A UI element handler component in attention director component 408a may send attention information for presenting a priority indicator by invoking output service 417a to interoperate, directly and/or indirectly, with an output device to present the priority indicator. Output service 417a may be operatively coupled to a display, a light, an audio device, a device that moves such as seat vibrator, a device that emits heat, a cooling device, a device that emits an electrical current, a device that emits an odor, and/or another output device that presents an output that may be sensed by an operator and/or other occupant.

In addition to or instead of including a UI handler component, attention director component 408a may interoperate with a user interface handler component included in output service 417a in order to present a priority indicator. The priority indicators may be represented by attributes of a user interface elements where the user interface elements represent the respective viewports. For example, attention director component 408a may send color information to present a color on a surface of automotive vehicle 502. The surface may include a viewport and/or may otherwise identify a viewport to an operator and/or other occupant. A color may be a priority indicator for the viewport. A first color may identify a higher priority indicator with respect to a lesser priority indicator based on a second color. For example, red may be defined as higher priority than orange, yellow, and/or green.

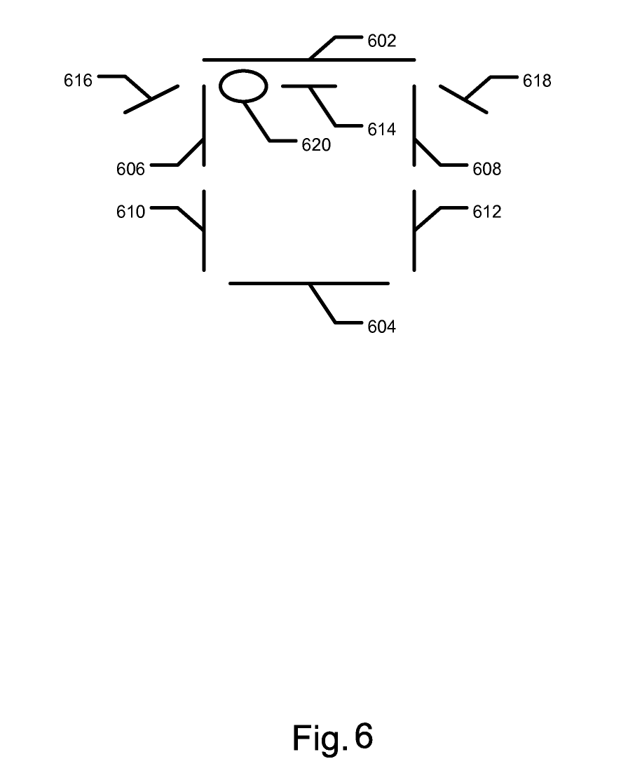

FIG. 6 illustrates user interface elements representing viewports to an operator and/or to another occupant of an automotive vehicle. A number of viewports are represented in FIG. 6 by respective line segment user interface elements. The presentation in FIG. 6 may be presented on a display in a dashboard, on a sun visor, in a window, and/or on any suitable surface of an automotive vehicle. FIG. 6 illustrates front indicator 602 representing a viewport including a windshield of automotive vehicle 502, rear indicator 604 representing a viewport including a rear window, front-left indicator 606 representing a viewport including a corresponding window when closed or at least partially open, front-right indicator 608 representing a viewport including a front-right window, back-left indicator 610 representing a viewport including a back-left window, back-right indicator 612 representing a viewport including a back-right window, rear-view display indicator 614 representing a viewport including a rear-view mirror and/or a display device, left-side display indicator 616 representing a viewport including a left-side mirror and/or display device, right-side display indicator 618 representing a viewport including a right-side mirror and/or display device, and display indicator 620 representing a viewport including a display device in and/or on a surface of automotive vehicle 502. The user interface elements in FIG. 6 may be presented via the display device represented by display indicator 620.

Attention information may include and/or identify presentation information representing a priority indicator for a viewport. The presentation information may include information for changing a border thickness in a border in a user interface element in and/or surrounding some or all of a viewport and/or a surface providing a viewport. For example, to attract attention to a view visible through the front-left mirror of automotive vehicle 502, attention director component 408a may send attention information to output service 417a to present front-left indicator 616 with a thickness that is defined to indicate to a driver operator and/or other occupant to look at the left-side mirror and/or to interact with the left-side mirror by looking at it with more attentiveness. A border thickness may be a priority indicator and a thickness and/or thickness relative to another priority indicator may identify a priority indicator as a higher priority indicator or a lesser priority indicator.

A visual pattern may be presented in and/or on a surface providing a viewport. For example, attention director component 408b may send a message via network 506 to automotive vehicle 502. The message may include attention information instructing a presentation device to present rear-view indicator 614 with a flashing pattern and/or a pattern of changing colors, lengths, and/or shapes. Various patterns may identify various respective priorities.

In another aspect, a light in a mirror in automotive vehicle 502 and/or a sound emitted by an audio device in and/or on the mirror may be defined to correspond to a viewport including the mirror. The light may be turned on to cause and/or increase interaction between an operator and/or other occupant and the viewport. Additionally or alternatively, the sound may be output. The light may identify the viewport as a higher priority viewport with respect to viewports without corresponding lights or other priority indicators.

In still another aspect, attention information may be sent to end an output. For example, the light and/or a sound may be turned off and/or stopped to cause interaction between an operator and a view provided via the mirror to end or otherwise decrease interaction.

A priority indicator to attract the attention of an operator and/or other occupant may provide relative priority information as described above. In an aspect, priority indicators may be presented based on a multi-point scale providing relative indications of a need for an operator and/or other occupant's interaction may be presented corresponding to multiple viewports. Viewports may be identified as higher priority or lesser priority viewports with respect to other viewports based on the points on the scale associated with the respective viewports. A multi-point scale may be presented based on text such as a numeric indicator and/or may be graphical, based on a size or a length of the indicator corresponding to a priority ordering.

For example, a first output may present a number to an operator and/or other occupant for a first viewport and a second output may include a second number for a second viewport. A number may be presented to attract the attention of the operator and/or other occupant. The size of the numbers may indicate a ranking or priority of one viewport over another. For example, if the first number is higher than the second number, the scale may be defined to indicate to the user interaction with the first viewport should occur instead of and/or before directing interaction with the second viewport. In another aspect, the first number may indicate that user interaction with the first viewport should be maintained at a higher level than the second viewport.

A user interface element, including a priority indicator, may be presented by a library routine of output service 417a. Attention director component 408b may change a user-detectable attribute of the UI element. For example, attention director component 408b in service node 504 may send attention information via network 506 to automotive vehicle 502 for presenting via an output device of automotive vehicle 502. A priority indicator may include information for presenting a new user interface element and/or to change an attribute of an existing user interface element to attract the attention of an operator and/or other occupant.

A region of a surface in automotive vehicle 502 may be designated for presenting a priority indicator. As described above a region of a surface of automotive vehicle 502 may include a screen of a display device for presenting the user interface elements illustrated in FIG. 6. A position on and/or in a surface of automotive vehicle 502 may be defined for presenting a priority indicator for a particular viewport provided by the surface or for a viewport otherwise identified by and/or with the position. In FIG. 6, each user interface element has a position relative to the other indicators. The relative positions define respective viewports. A portion of a screen in a display device may be configured for presenting one or more priority indicators.

An attention director component 408 in FIG. 4a and/or in FIG. 4b may provide a priority indicator that indicates how soon a viewport requires attention of an operator and/or other occupant. For example, changes in size, location, and/or color may indicate whether a viewport requires attention and may give an indication of how soon a viewport may need attention and/or may indicate a level of attention suggested and/or required. A time indication for attention may give an actual time and/or a relative indication may be presented.

A viewport may be visible via a surface of an automotive vehicle and attention information may be sent to direct the attention of the operator and/or other occupant to the surface. Attention handler component 408b may send attention information in a message via network 506 to automotive vehicle 502 for presenting by output service 417a via an output device. Output service 417a may be operatively coupled to a projection device for projecting a user interface element as and/or including a priority indicator on a windshield of automotive vehicle 502 to attract the attention of a driver to a viewport of an outside space visible via the windshield. A priority indicator may be included in and/or may include one or more of an audio interface element, a tactile interface element, a visual interface element, and an olfactory interface element.

Attention information may include time information identifying a duration for presenting a priority indicator to maintain the attention of an operator and/or other occupant. For example, a vehicle may be detected approaching automotive vehicle 502. Priority indicator may be presented by attention director component 408a in FIG. 4a for maintaining a driver's interaction with a viewport including the approaching vehicle. The priority indicator may be presented for an entire duration of time that the vehicle is approaching automotive vehicle 502 or for a specified portion of the entire duration.

A user-detectable attribute and/or element of a presented output may be defined to identify a viewport to an operator and/or to another occupant. For example, in FIG. 6 each line segment is defined to identify a particular viewport. A user-detectable attribute may include one or more of a location, a pattern, a color, a volume, a measure of brightness, and a duration of the presentation. A location may be one or more of in front of, in, and behind a surface of the automotive vehicle in which a viewport is visible. A location may be adjacent to a viewport and/or otherwise in a specified location relative to a corresponding viewport. A priority indicator may include a message including one or more of text data and voice data.

The method illustrated in FIG. 2 may include additional aspects supported by various adaptations and/or analogs of the arrangement of components in FIG. 3. For example, in various aspects, interaction information may be received based on input detected by at least one of a gaze detector, a motion sensing device, a touch sensitive input device, and an audio input device. For example, in FIG. 4a interaction monitor component 402a may include and/or otherwise be operatively coupled to a motion sensing device for detecting a hand motion near a compact disc player. Interaction information may be based on a motion detected by the motion sensing device for the compact disc player.

In another aspect, a directional microphone may detect voice activity from a driver and/or other operator and/or other occupant in automotive vehicle 502 and provide interaction information to one or both of interaction monitor component 402a and interaction monitor component 402b. The microphone may be integrated in automotive vehicle 502, worn by an operator and/or other occupant, and/or otherwise included in automotive vehicle 502.

A viewport may include and/or be identified by an input control for detecting an input from an automotive vehicle operator and/or other occupant. An input control may be presented via an electronic display device or may be a hardware control. For example, a viewport corresponding to a side view mirror may be associated with a button on a steering wheel. An operator of an automotive vehicle including the mirror and steering wheel may press the button to acknowledge a priority indicator presented corresponding to the side view mirror.

In an aspect, a component for receiving interaction information may be activated and/or deactivated in response to user input received from the operator and/or another occupant in an automotive vehicle, a message received via a network, a communication received from a portable electronic device, and/or an event detected by an automotive vehicle. Exemplary events for activating and/or deactivating monitoring in an automotive vehicle include insertion of a key in a lock, removal of a key, a change in motion, a change in velocity, a change in direction, identification of the operator, a change in a number of occupants, a change in an ambient condition, a change in an operating status of a component of the automotive vehicle, and/or a change in location of the automotive vehicle.

Interaction information received may be defined and/or otherwise based on an attribute of an occupant of an automotive vehicle, a count of occupants in the automotive vehicle, a count of audible occupants in the automotive vehicle, an attribute of the automotive vehicle, an attribute of a viewport, a speed of the automotive vehicle, a view visible to the operator via a viewport, a direction of movement of at least a portion of the operator, a start time, an end time, a length of time, a direction of movement of an automotive vehicle, an ambient condition in the automotive vehicle for the operator, an ambient condition for the automotive vehicle, a topographic attribute of a location including the automotive vehicle, an attribute of a route of the automotive vehicle, information from a sensor external to the automotive vehicle, and/or information from a sensor included in the automotive vehicle. For example, interaction information may be based on a sound in an automotive vehicle. The interaction information may be based on a source of an audible activity that may attract an operator's attention, a change in volume of sound, and/or detection of an expected sound.

In another example, topographic information for a location of automotive vehicle 502 may determine a time period and/or an attention criterion, based on a measure of visual interaction, suitable to the topography of the location. A mountainous topography, for example, may be associated with a more sensitive method for detecting interaction information and/or for identifying a more sensitive attention criterion than a flat topography.

As described, a viewport of an automotive vehicle may be visible to an operator and/or other occupant via a surface included in the automotive vehicle. Exemplary surfaces include a reflective surface, a surface that is at least partially transparent, a surface defined by a window casing, a surface of a display device, a surface receiving a projected viewport, and a surface including an input control.

Receiving interaction information may include determining a measure of an audible activity in and/or external to the automotive vehicle. A measure of audible activity may be based on, for example, a number of audible active occupants in the automotive vehicle, a volume of an audio device, and/or unexpected sounds detected that may originate in and/or external to an automotive vehicle. Receiving interaction information may further include identifying one or more of a source and a location of a source of the audible activity. An interaction monitor component 402 may receive audio interaction information from audio input devices on and/or otherwise near an operator and/or other occupant and/or may receive audio input from multiple audio input devices for determining a source location via a triangulation technique based on a volume and/or relative time an audio activity is detected by the audio input devices. One or more audio input devices may provide interaction information to interaction monitor component 402b via network 506. Attention service 403b, in an aspect may receive audio information in response to an audio input detected by automotive vehicle 502. Interaction monitor component 402b may determine whether a specified attention criterion has been met based on a criterion specification stored in policy data store 413b. For example, interaction information may be received based on audio input identifying a measured decibel level of audio activity detected by automotive vehicle 502 that exceeds a level specified by an attention criterion selected in response to receiving the information identifying the decibel level.

Interaction information may be received via communication with a portable electronic device, in an automotive vehicle, that is not part of the automotive vehicle. The portable electronic device may include a mobile phone, a media player, a media recorder, a notebook computer, a tablet computer, a netbook, a personal information manager, a media sharing device, an email client, a text message client, and/or a media messaging client, to name a few examples. For example, an operator of an automotive vehicle may provide input to a mobile phone.

An interaction monitor component 402 may receive interaction information from the mobile phone in response to the operator input received and/or otherwise detected by the mobile phone. For example, a touch screen of a mobile device, such as mobile phone and/or tablet computing device, in automotive vehicle 502 may detect touch input. The operator of automotive vehicle 502 may be logged into the mobile device. The device may include a network interface component such as an 802.11 wireless adapter and/or a BLUETOOTH® adapter. The device may send interaction information to interaction monitor component 402b in service node 504 via network 506 and/or may send interaction information to interaction monitor component 402a in FIG. 4a via a personal area network (PAN) and/or a wired connection to automotive vehicle 502.

Receiving interaction information for an operator may include detecting an eyelid position, an eyelid movement, an eye position, an eye movement, a head position, a head movement, a substance generated by at least a portion of a body of the operator, a measure of verbal activity, and/or a substance taken in bodily by the operator, to name some examples.

In addition to monitoring the operator, monitoring may include receiving interaction information for one or more other occupants of the automotive vehicle. Interaction information received based on the monitoring may include information from monitoring the one or more other occupants of the automotive vehicle.

Detecting that an attention criterion is met may include identifying a measure of interaction based on a specified interaction metric, and determining that the attention criterion is met based on the measure of interaction. For example, a measurement of a drug and/or hormone in an operator may be included in determining whether an attention criterion is met.

Detecting that an attention criterion is met may be based on time information including at least one of a start time, an end time, and a length of time identified. The time information may be identified based on an event in a plurality of events that occur irregularly in time. A length of the time period may be based on at least one of a relative time metric and an absolute time metric. For example, a length of time may be a length of time associated with monitoring the operator based on a first viewport. Detecting that an attention criterion is met may include detecting whether the attention criterion is met based on the length of time. The attention criterion may be determined to be met in response to detecting that the length of time meets a threshold condition.

An attention criterion may be defined and/or otherwise specified based on an attribute of an occupant of the automotive vehicle, a count of occupants in the automotive vehicle, an attribute of the automotive vehicle, an attribute of a viewport, a speed of the automotive vehicle, a view viewable to the operator, a direction of movement of at least a portion of the operator, a direction of movement of an automotive vehicle, an ambient condition in the automotive vehicle for the operator, an ambient condition for the automotive vehicle, a topographic attribute of a location including the automotive vehicle, an attribute of a route of the automotive vehicle, information from a sensor external to the automotive vehicle, and/or information from a sensor included in the automotive vehicle.

In an aspect, determining that a first viewport is a higher priority viewport than a second viewport may include determining an order of the first viewport and the second viewport according to a specified priority criterion. A priority criterion may be based on a length of time associated with a met attention criterion for a viewport, a most recent attention criterion met, a past order of viewports of the automotive vehicle having met attention criteria, a viewport of the automotive vehicle having a higher priority than the first viewport and the second viewport, an attribute of the automotive vehicle, an attribute of an occupant of the automotive vehicle, an attribute of a second automotive vehicle, an attribute of an occupant of the second automotive vehicle, an attribute of a viewport, an object external to the automotive vehicle visible in a viewport of the automotive vehicle, a speed of the automotive vehicle, a direction of movement of the automotive vehicle, an object in a viewport, a specified destination, a location of the automotive vehicle in a specified route, an ambient condition for the operator, an ambient condition external to the automotive vehicle, an attribute of an occupant, a count of occupants in the automotive vehicle, an attribute of a cargo included in the automotive vehicle, an attribute of sound detectable in the automotive vehicle, and/or an attribute of a road.

An order identified by a specified priority criterion may be selected prior to detecting that an attention criterion is met. In another aspect, a priority criterion order may be determined and/or otherwise identified in response to detecting that a first attention criterion is met and detecting that a second attention criterion is met. That is an order may be determined dynamically and may vary between two viewports over time.

Presenting a higher priority indicator may include presenting a change to a user interface element identifying a viewport. A presented priority indicator may indicate a raising or a lowering of a priority for a particular viewport with respect to another priority indicator. The change may include a change to at least one of a z-value, a level of transparency, a location in a presentation space, a size, a shape of the user interface element, an output type, and an output device. A higher priority indicator may be presented based on a location of a viewport in the automotive vehicle as described above with respect to FIG. 6.

The method illustrated in FIG. 2 may further include determining that the second viewport has a higher priority than the first viewport, subsequent to sending the first attention information. In response to determining the second viewport has the higher priority; second attention information may be sent to present a second priority indicator to direct the attention of the operator to the second viewport rather than the first viewport.

In another aspect, attention information for presenting a priority indicator may include and/or otherwise identify a duration for presenting a priority indicator for maintaining interaction between the operator and a particular viewport.

A priority indicator may be presented as a lesser or a higher priority indicator than another priority indicator based on, at least one of a time of presentation, a size, a color, a pattern of presentation, a location, a number, a letter, a level of brightness, a level of contrast, a z-value, a level of transparency, and/or a level of audible volume, to name some examples. A priority indicator may include an audio interface element, a tactile interface element, a visual interface element, and/or an olfactory interface element.

A priority indicator may be presented on a same surface of an automotive vehicle that provides a viewport. In another aspect, a priority indicator may be provided via a surface not providing the particular viewport but that is configured to identify the viewport. FIG. 6 illustrates an example of multiple priority indicators presented via output service 417a in FIG. 4a by attention director component 408a in a display in a surface of automotive vehicle 502 rather than or in addition to priority indicators presented in respective surfaces providing viewports.

A priority indicator may be presented by attention director component 408a in FIG. 4a for a specified duration of time and/or until a specified event is detected, and/or may include a pattern of changes presented to an operator and/or other occupant of an automotive vehicle. For example, a priority indicator may be presented until an operator and/or other occupant input is detected that corresponds to the priority indicator and acknowledges that the operator and/or other occupant is aware of the priority indicator. In response to detecting the operator and/or other occupant input, the presentation of the priority indicator may be removed and/or otherwise stopped. Interaction monitor component 402a and/or another input handler (not shown) in execution environment 401a may be configured to detect a user input from an operator and/or other occupant acknowledging a priority indicator.

An attention criterion for a viewport may be based on time period that is relatively shorter for a relatively older driver beyond a specified age. Shorter time periods may be detected when an automotive vehicle is being driven in rainy weather as opposed to sunny weather. Attention priority component 406a in FIG. 4a and/or attention priority component 406b in FIG. 4b may access an instruction and/or policy for identifying an attention criterion by performing a look up based on one or more of the attributes listed in this paragraph as well as other attributes not listed.

Determining that an attention criterion is met and/or identifying an attention criterion to evaluate may be based on one or more of interaction information, a viewport, a surface in which a viewport is visible to an operator and/or other occupant, an object visible in a viewport, an attribute of an operator and/or other occupant such as an age, a measure of visual acuity, a measure of sleepiness, a measure of driving aptitude such as a measure of driving experience, a temporal measure, a count of operator and/or other occupants in the automotive vehicle, an attribute of an automotive vehicle such as speed and/or direction of movement, a movement of a steering mechanism of an automotive vehicle, an ambient condition, a topographic attribute of a location including an automotive vehicle, a road, information from a sensor external to an automotive vehicle, a role of an operator and/or other occupant, and information from a sensor included in an automotive vehicle. In FIG. 4a, attention priority component 406a may locate a specification of an attention criterion based on one or more of the attributes listed. Alternatively or additionally, attention priority component 406a may test a specified attention criterion based on one or more of the attributes listed in this paragraph to determine whether the condition is met.

A threshold duration may be based on interaction information, a viewport, a surface in which a viewport is visible to an operator and/or other occupant, an object visible in a viewport, an attribute of an operator and/or other occupant such as an age, a measure of visual acuity, a measure of sleepiness, a measure of driving aptitude such as a measure of driving experience, a temporal measure, a count of operator and/or other occupants in the automotive vehicle, an attribute of an automotive vehicle such as speed and/or direction of movement, a movement of a steering mechanism of an automotive vehicle, an ambient condition, a topographic attribute of a location including an automotive vehicle, a road, information from a sensor external to an automotive vehicle, a role of an operator and/or other occupant, and information from a sensor included in an automotive vehicle. For example, a threshold duration for a front viewport via a windshield by be shorter relative to threshold for a viewport visible via a rear window. One or more threshold durations and/or threshold conditions may be stored in a policy data store 413 and accessed by a viewport monitor component 404 to determine whether an attention criterion is met. A threshold duration and/or a threshold condition may be specified based on user input and/or may be received via a network from a remote node.

Determining that an attention criterion is met may include evaluating the attention criterion by comparing a first time period associated with a first viewport with a second time period associated with a second viewport. For example, viewport monitor component 404a may be configured to detect a percentage of a time period an operator and/or other occupant is interacting with two or more viewports. The time period may vary based on the operator and/or other occupant, road conditions, and/or other attributes for which examples have been provided above.

To the accomplishment of the foregoing and related ends, the descriptions herein and the referenced figures set forth certain illustrative aspects and/or implementations of the subject matter described. These are indicative of but a few of the various ways the subject matter may be employed. The other aspects, advantages, and novel features of the subject matter will become apparent from the detailed description included herein when considered in conjunction with the referenced figures.

It should be understood that the various components illustrated in the various block diagrams represent logical components that are configured to perform the functionality described herein and may be implemented in software, hardware, or a combination of the two. Moreover, some or all of these logical components may be combined, some may be omitted altogether, and additional components may be added while still achieving the functionality described herein. Thus, the subject matter described herein may be embodied in many different variations, and all such variations are contemplated to be within the scope of what is claimed.

To facilitate an understanding of the subject matter described above, many aspects are described in terms of sequences of actions that may be performed by elements of a computer system. For example, it will be recognized that the various actions may be performed by specialized circuits or circuitry (e.g., discrete logic gates interconnected to perform a specialized function), by program instructions being executed by one or more instruction-processing units, or by a combination of both. The description herein of any sequence of actions is not intended to imply that the specific order described for performing that sequence must be followed.

Moreover, the methods described herein may be embodied in executable instructions stored in a computer-readable medium for use by or in connection with an instruction execution machine, system, apparatus, or device, such as a computer-based or processor-containing machine, system, apparatus, or device. As used here, a “computer-readable medium” may include one or more of any suitable media for storing the executable instructions of a computer program in one or more of an electronic, magnetic, optical, electromagnetic, and infrared form, such that the instruction execution machine, system, apparatus, or device may read (or fetch) the instructions from the computer-readable medium and execute the instructions for carrying out the described methods. A non-exhaustive list of conventional exemplary computer-readable media includes a portable computer diskette; a random access memory (RAM); a read only memory (ROM); an erasable programmable read only memory (EPROM or Flash memory); and optical storage devices, including a portable compact disc (CD), a portable digital video disc (DVD), a high definition DVD (HD-DVD™), and a Blu-ray™ disc; and the like.

Thus, the subject matter described herein may be embodied in many different forms, and all such forms are contemplated to be within the scope of what is claimed. It will be understood that various details may be changed without departing from the scope of the claimed subject matter. Furthermore, the foregoing description is for the purpose of illustration only, and not for the purpose of limitation, as the scope of protection sought is defined by the claims as set forth hereinafter together with any equivalents.

All methods described herein may be performed in any order unless otherwise indicated herein explicitly or by context. The use of the terms “a” and “an” and “the” and similar referents in the context of the foregoing description and in the context of the following claims are to be construed to include the singular and the plural, unless otherwise indicated herein explicitly or clearly contradicted by context. The foregoing description is not to be interpreted as indicating that any non-claimed element is essential to the practice of the subject matter as claimed.

I claim:

1. A method for directing attention of an occupant of an automotive vehicle to a viewport, the method comprising:
receiving, via an input device, interaction information for monitoring an operator of an automotive vehicle that includes a first viewport as a first source of visual input for the operator and that includes a second viewport as a second source of visual input for the operator;
detecting, based on the interaction information, that a first attention criterion is met for the first viewport and that a second attention criterion is met for the second viewport;
determining, in response to detecting that the first attention criterion is met and that the second attention criterion is met, that the first viewport has a higher priority than the second viewport; and
sending, in response to determining that the first viewport has the higher priority, first attention information to present a first priority indicator, to the operator, via a first output device, to identify the first viewport as a higher priority source of visual input for the operator than the second viewport.

2. The method of claim 1 wherein the first viewport includes at least a portion of at least one of a window, a display of an electronic display device, and a mirror and the second viewport includes at least a portion not included in the first viewport of at least one of a window, a display of an electronic display device, and a mirror

3. The method of claim 1 wherein at least one of the first viewport and the second viewport provides a view via at least one of a screen included in an electronic display device and an image projected onto a surface by a display device.

4. The method of claim 1 wherein receiving the interaction information includes activating a monitoring component for receiving the interaction information in response to an input received from at least one of an occupant in the automotive vehicle, a message received via a network, a communication received from a portable electronic device, an event detected by the automotive vehicle.

5. The method of claim 1 wherein the interaction information that identifies at least one of a direction of operator interaction, an object with which the operator is interacting, and a measure of interaction between the operator and an object, wherein the measure is based on a specified interaction metric.

6. The method of claim 5 wherein the interaction information is based on at least one of an attribute of an occupant of the automotive vehicle, a count of occupants in the automotive vehicle, a count of audible occupants in the automotive vehicle, an attribute of the automotive vehicle, an attribute of a viewport, a speed of the automotive vehicle, an object viewable to the operator via a viewport, a direction of movement of at least a portion of the operator, a start time, an end time, a length of time, a direction of movement of an automotive vehicle, an ambient condition in the automotive vehicle, an ambient condition for the automotive vehicle, a topographic attribute of a location including the automotive vehicle, an attribute of a route of the automotive vehicle, information from a sensor external to the automotive vehicle, and information from a sensor included in the automotive vehicle.

7. The method of claim 6 wherein the interaction information is received based on a change in the at least one of the attributes,

8. The method of claim 5 wherein receiving the interaction information includes communicating with a portable electronic device in the automotive vehicle that is not part of the automotive vehicle.

9. The method of claim 8 wherein the portable electronic device includes at least one of a mobile phone, a media player, a media recorder, a notebook computer, a tablet computer, a netbook, a personal information manager, a media sharing device, an email client, a text messaging client, and a media messaging client.

10. The method of claim 8 wherein communicating with the portable electronic device includes receiving the interaction information in response to an input detected by the portable electronic device.

11. The method of claim 1 wherein the interaction information is received based on an input detected from an occupant of the automotive vehicle that is not the operator.

12. The method of claim 1 where in detecting at least one of the first attention criterion and the second attention criterion comprises:
identifying a measure of interaction based on a specified interaction metric; and
determining that the at least one of the first attention criterion is met and the second attention criterion is met based on the measure of interaction.

13. The method of claim 1 wherein detecting a least one of the first attention criterion and the second attention criterion is based on time information associated with receiving the interaction information, that identifies at least one of a start time, an end time, and a length of time.

14. The method of claim 1 wherein determining that the first viewport has the higher priority includes determining an order of the first viewport and the second viewport according to a specified priority criterion.

15. The method of claim 1 wherein presenting the first priority indicator includes presenting a change to a user interface element identifying at least one of the first viewport and the second viewport.

16. The method of claim 1 wherein the first priority indicator is presented in a first location based on a second location of the first viewport in the automotive vehicle.

17. The method of claim 1 further includes continuing to present the first higher priority indicator until a user input is detected that is defined to acknowledge the presented first priority indicator.

18. The method of claim 1 further includes sending second attention information to present a second priority indicator, to the operator, to identify the second viewport as a next higher priority source of visual input.

19. A system for directing attention of an occupant of an automotive vehicle to a viewport, the system comprising:
an interaction monitor component, a viewport monitor component, an attention priority component, and an attention director component adapted for operation in an execution environment;
the interaction monitor component configured for receiving, via an input device, interaction information for monitoring an operator of an automotive vehicle that includes a first viewport as a first source of visual input for the operator and that includes a second viewport as a second source of visual input for the operator;
the viewport monitor component configured for detecting, based on the interaction information, that a first attention criterion is met for the first viewport and that a second attention criterion is met for the second viewport;
the attention priority component configured for determining, in response to detecting that the first attention criterion is met and that the second attention criterion is met, that the first viewport has a higher priority than the second viewport; and
the attention director component configured for sending, in response to determining that the first viewport has the higher priority, first attention information to present a first priority indicator, to the operator, via a first output device, to identify the first viewport as a higher priority source of visual input for the operator than the second viewport

20. A computer-readable medium embodying a computer program, executable by a machine, for directing attention of an occupant of an automotive vehicle to a viewport, the computer program comprising executable instructions for:
receiving, via an input device, interaction information for monitoring an operator of an automotive vehicle that includes a first viewport as a first source of visual input for the operator and that includes a second viewport as a second source of visual input for the operator;
detecting, based on the interaction information, that a first attention criterion is met for the first viewport and that a second attention criterion is met for the second viewport;
determining, in response to detecting that the first attention criterion is met and that the second attention criterion is met, that the first viewport has a higher priority than the second viewport; and
sending, in response to determining that the first viewport has the higher priority, first attention information to present a first priority indicator, to the operator, via a first output device, to identify the first viewport as a higher priority source of visual input for the operator than the second viewport.
